(19) United States
(12) Patent Application Publication
(10) Pub. No.: US 2007/0053287 A1
(43) Pub. Date: Mar. 8, 2007

(54) System and method for selecting data rates in a wireless communication system

(76) Inventors: Gang Li, Bridgewater, NJ (US); Ming Lu, Hillsborough, NJ (US); Martin Howard Meyers, Montclair, NJ (US)

Correspondence Address: Michael G. Fletcher;FLETCHER YODER, P.O. Box 692289, Houston, TX, 77269-2289, US

(21) Appl. No.: 11/221,267

(22) Filed: Sep. 7, 2005

(51) Int. Cl. H04L 12/26; H04Q 7/00; H04J 3/22; H04L 1/00; H04J 3/16

(52) U.S. Cl. 370/229; 370/465; 370/328

(57) ABSTRACT

There is provided a system and method and apparatus for selecting data rates in a wireless communication system. More specifically, there is provided a method comprising selecting one of a plurality of data rate control values for a transmission based on an adjustable relationship between the selected data rate control value and a transmission error margin related to the selected data rate control value.

### BACKGROUND OF THE INVENTION

1. Field Of The Invention

The present invention relates generally to telecommunications and, more particularly, to wireless communication.

2. Description Of The Related Art

This section is intended to introduce the reader to various aspects of art that may be related to various aspects of the present invention, which are described and claimed below. This discussion is believed to be helpful in providing the reader with background information to facilitate a better understanding of the various aspects of the present invention. Accordingly, it should be understood that these statements are to be read in this light, and not as admissions of prior art.

One of the paramount challenges facing modem wireless telephone systems is the rapid growth of consumer demand for data services such as Internet access, text messaging, and e-mail. In fact, consumers are demanding greater access to data-related services than ever before, and this trend is not likely to change. For example, in the coming years, consumers will likely expect their mobile devices (e.g., wireless telephones) to provide many, if not all, of the digital data communication features currently provided by computers (e.g., video conferencing, picture mail, etc.).

One method of transmitting digital data, such as digital photos, web pages, or videos, is with packets. A packet is a unit of data capable of being routed through a computer network. Packets typically include a packet header that contains the intended destination for the data, a payload that contains the data being transmitted, and some form of error checking information. Typically, a transmitting device will divide a message or file into a plurality of packets that will be transmitted across the network to a receiving device. The receiving device will then reassemble the packets into the original message or file. If one or more of the packets does not arrive at the receiver or arrives and cannot be decoded, the receiver can request a replacement packet from the transmitter. In this way, packetizing data may permit more efficient transmission of data by limiting the amount of data that should be resent as a result of an error.

For the reasons stated above, packetizing data is a logical choice for transmitting data to a mobile device. Over the past few years, a variety of systems have been developed to transmit packetized data over wireless communication networks. These system include, but are not limited to, Evolution Voice-Data Only (“EV-DO”), 1X Evolution Voice-Data Voice (“1x EV-DV”), High Speed Downlink Packet Access (“HSDPA”) for Universal Mobile Telecommunication System (“UMTS”). Although the specific implementation details of each of these systems may vary, each adds at least one additional channel to carry packetized data.

In a typical wireless communication system, a base station subdivides the one or more additional packet channels into a plurality of time slots, which can then be allocated to a plurality of mobile devices through a process known as time division multiplexing. For example, a first mobile device may have access to the packet channel for 5 milliseconds (“ms”), then a second user for 3 ms, and so forth. Once a time slot has been allocated to one of the mobile devices, the base station may transmit packetized data to that particular mobile device during that mobile device's “slice” of the packet channel.

Modern wireless systems, however, may also have the capacity to assign each of the plurality of mobile devices its own specific data rate to use during that mobile device's slice of the packet channel. For example, the base station may communicate with one of the mobile devices at a data rate of 38.4 kilobits per second (“kbps”) and another one of the mobile devices at 307.2 kbps. In addition, the base station may also employ a variety of packet sizes, which are referred to as transmission formats. For example, if one of the mobile devices has a 3.33 ms slice of the packet channel, the base station may be able to transmit either one 3.33 ms long packet or two 1.667 ms packets during that slice. Likewise, if the mobile device's slice is 6.66 ms, the base station may transmit one 6.66 ms long packet, two 3.33 ms long packets, or four 1.667 ms long packets.

As described above, the base station may transmit packets to one or more mobile devices over slices of the packet channel. The success or failure of these packet transmissions can be gauged with an error metric, such as a packet error rate (“PER”). The PER may correspond to the data rate, the transmission format, and the radio frequency (“RF”) conditions (hereafter referred to as the channel conditions) between each of the mobile devices and the base station. For example, if channel condition worsen while the data rate and transmission format remain static, the PER will increase. For many reasons, however, it may be desirable for the base station to attempt to maintain the PER for the packet channel at or around a PER target value.

For this reason, the mobile devices and/or the base station may be configured to adjust the data rate or transmission format based on changes in the channel conditions, which can be gauged using a measured signal-to-noise ratio (” SNR”) on transmissions between the base station and the mobile devices. As such, base station conventionally employed static relationships between a measured SNR and predicted PER to adjust data rates to maintain the PER around the PER target value. However, because these relationships are static, they cannot be adjusted if channel conditions or other factors change the relationship between PER and SNR. Further, because conventional base stations use a previously measured SNR to select a data rate and/or transmission, conventional base stations may not be certain that the SNR used to select the data rate and/or transmission format for a packet transmission will be similar to the SNR of the actual packet transmission.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The embodiments of the present invention may be directed toward addressing the above-described issues. The present invention provides a system and method and apparatus for selecting data rates in a wireless communication system. An exemplary method of the present invention comprises selecting one of a plurality of data rate control values for a transmission based on an adjustable relationship between the selected data rate control value and a transmission error margin related to the selected data rate control value.

### BRIEF DESCRIPTION OF THE DRAWINGS

Advantages of the invention may become apparent upon reading the following detailed description and upon reference to the drawings in which:

FIG. 1 illustrates a block diagram of an exemplary wireless communication system in accordance with an embodiment of the present invention;

FIG. 2 illustrates a block diagram of an exemplary mobile device in accordance with embodiments of the present invention;

FIG. 3 is a flow chart illustrating an exemplary technique for calculating signal-to-noise ratio prediction error in accordance with embodiments of the present invention;

FIG. 4 is a flow chart illustrating an exemplary technique for adjusting a threshold offset based on channel conditions in accordance with embodiments of the present invention;

FIG. 5 is a flow chart illustrating an exemplary technique for adjusting signal-to-noise ratio threshold margins for a plurality of data rate control values in accordance with embodiments of the present invention; and

FIG. 6 is a flow chart illustrating an exemplary technique for selecting a data rate control value in accordance with embodiments of the present invention.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions should be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The embodiments described herein may be directed towards a system or a method for selecting data rates in a wireless communication system. Specifically, in one embodiment, a mobile device may adjust the relationship (referred to as the signal-to-noise ratio (“SNR”) threshold margins) between one or more data rate control (“DRC”) values and a particular SNR for a given packet error rate (“PER”) target on the packet channel. The mobile device may also use these SNR threshold margins in conjunction with a predicted future value for the SNR to select a data rate and transmission format (e.g., a DRC) for a base station to use to transmit data to the mobile device over the packet channel.

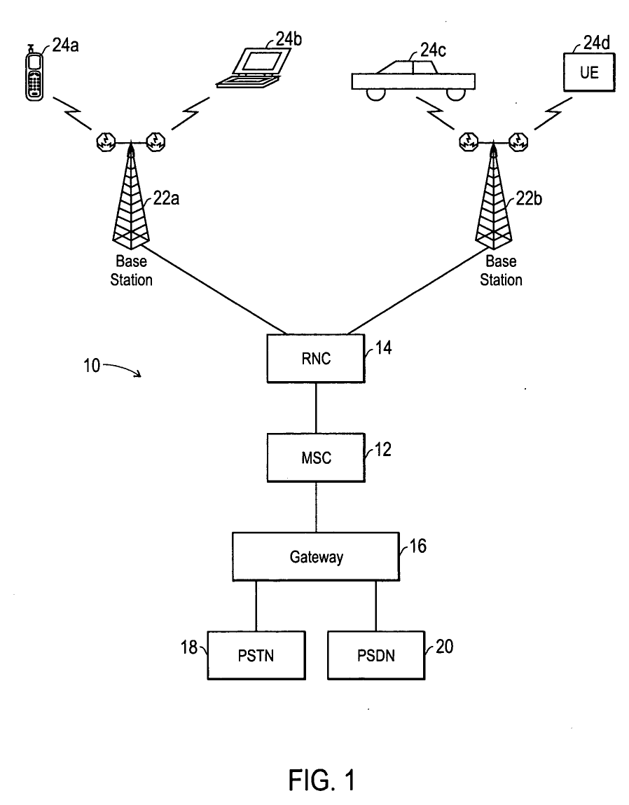

Turning now to the drawings, and referring initially to FIG. 1, a block diagram of an exemplary wireless communication system is illustrated and generally designated by a reference numeral 10. Those of ordinary skill in the art will appreciate that the wireless communication system 10, described below, illustrates merely one embodiment of a system for selecting data rates in a wireless communication system, such as an Evolution Voice-Data Only (“EV-DO”) system. As such, those of ordinary skill in the art will appreciate that the techniques described herein may be employed in a wide variety of wireless telephone communication systems including, but not limited to CDMA2000 3G-1X, 1X EV-DV, and HSDPA (UTMS). Moreover, it will also be appreciated that while the embodiment described below involves transmission from a base station to a mobile device (e.g., the forward link), with slight modifications, the techniques described herein could also be employed for communication over the reverse link (e.g., from the mobile device to the base station).

In any given wireless telephone market, such as a typical metropolitan area, the wireless telephone system 10 may include at least one mobile switching center (“MSC”) 12. The MSC 12 is a switch that serves the wireless telephone system 10. The primary purpose of the MSC 12 is to provide a voice path and/or a data path between a mobile device and another telephone or data source. The typical MSC 12 includes a number of devices, such as computerized call routers, that control switching functions, call processing, channel assignments, data interfaces, tracking, paging, call handoff, and user billing. The MSC 12 may be coupled to a gateway 16, which in turn may be coupled to a public switched telephone network (“PSTN”) 18, which is often referred to as a land line telephone network. The wireless telephone system 10 typically includes a connection to the PSTN 18, because a majority of all wireless telephone calls pass through the PSTN 18. The gateway 16 may also be coupled to a packet switch data network (“PSDN”) 20, such as the Internet, so as to provide Internet service to wireless telephone users. One or more radio network controllers (“RNC”) 14 may also be coupled to the MSC 12. The RNC 14 may control the use and reliability of radio resources within the wireless telephone system 10. Specifically, the RNC 14 may control the allocation and release of specific radio resources to establish a connection between mobile devices (see below) and the MSC 12.

The RNC 14 may be communicatively coupled either by wire or wirelessly to one or more base stations 22a and 22b. The base stations 22a and 22b are transmission and reception stations that act as access points for network traffic from a variety of mobile devices 24a, 24b, 24c, and 24d. As such, the base stations 22a and 22b may communicate voice or data with any suitable mobile device, such as a portable wireless telephone 24a, a laptop computer 24b, a vehicle system 24c, or other user equipment 24d. While only two base stations 22a and 22b are illustrated in FIG. 1, those of ordinary skill in the art will appreciate that any suitable number of base stations 22a and 22b may be coupled to the RNC 14.

Before beginning a more detailed description of the operation of the mobile devices 24a, 24b, 24c, and 24d, it may be helpful to present an overview of data rate/transmission format synchronization between the base station 22a, b and the mobile devices 24a, 24b, 24c, and 24d in accordance with one embodiment. As will be appreciated, to communicate efficiently with one another, the base station 22a, b and the each of the mobile devices 24a, 24b, 24c, and 24d are programmed with the data rate and the transmission format that the base station 22a, b is going to use to transmit to each of the mobile devices 24a, 24b, 24c, and 24d. For example, if the base station 22a, b is transmitting to the mobile device 24a at 614.4 kbps with one packet every 1.667 milli-seconds, the mobile device 24a will be aware of the data rate and the transmission format. Likewise, the mobile device 24b may be programmed with the data rate and transmission format that the base station 22a, b is using to transmit to the mobile device 24b (which may be different than the data rate and transmission format associated with the mobile device 24a), and so forth.

In one embodiment, the base station 22a, b and the mobile devices 24a, 24b, 24c, and 24d may be preprogrammed with a plurality of data rates and transmission format combinations, each of which is assigned a number, referred to a data rate control (“DRC”) number. As such, data rates and transmission formats may be hereafter referred to as DRCs. The plurality DRCs may be compiled into a preferred DRC list, such as Table 1 below.

TABLE 1

| Data Rate | Date Rate | Maximum Transmission Span |
|---|---|---|
| Control Number | (in kbps) | Packet Length (in 1.667 ms slots) |
| 1 | 38.4 | 16 |
| 2 | 76.8 | 8 |
| 3 | 153.6 | 4 |
| 4 | 307.2 | 2 |
| 5 | 307.2 | 4 |
| 6 | 614.4 | 1 |
| 7 | 614.4 | 2 |
| 8 | 921.6 | 2 |
| 9 | 1228.8 | 1 |
| 10 | 1228.8 | 2 |
| 11 | 1843.2 | 1 |
| 12 | 2457.6 | 1 |

The DRC numbers enable the mobile devices 24a, 24b, 24c, and 24d to identify to the base stations 22a, b which data rate and transmission format the base station 22a, b should use to transmit data to each of the mobile device 24a, 24b, 24c, and 24d, so that the mobile devices 24a, 24b, 24c, and 24d can decode the transmissions. It will be appreciated that the Table 1 and the twelve DRCs listed in Table 1 are exemplary and presented for ease of illustration. In alternate embodiments, any one of a number of suitable DRCs may be included in the preferred DRC list.

As illustrated in Table 1, the transmission format identifies how many slots each transmitted packet may span (e.g., the maximum packet length). Depending on the channel conditions between the base station 22a, b and the mobile devices 24a, 24b, 24c, and 24d, the base station may span transmission of a packet across up to sixteen slots. For example, looking at Table 1, if the channel conditions are relatively poor, a single packet may be spanned across sixteen slots resulting in a data rate of 38.4 kbps. On the other hand, if channel conditions are favorable, a packet may be transmitted in a single slot, which may enable a data rate between 614.4 kbps and 2457.6 kbps.

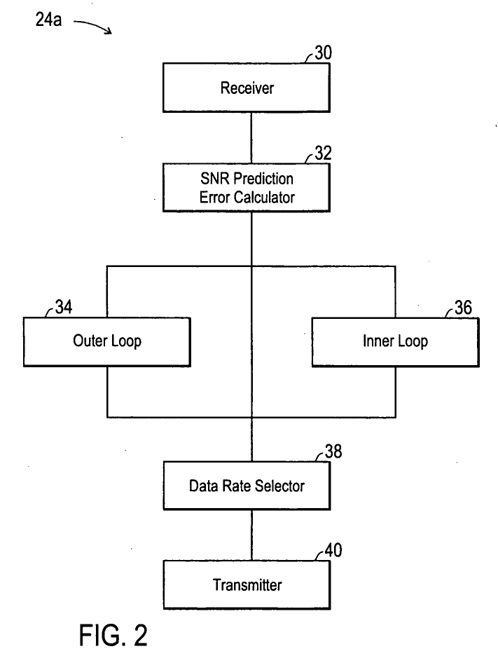

Returning now to the Figures, FIG. 2 illustrates a block diagram of an exemplary mobile device 24a in accordance with one embodiment. It will be appreciated that while the mobile device 24a was selected from amongst the mobile devices 24a, 24b, 24c, 24d for ease of description, and as such, alternate embodiments may include the mobile devices 24b, 24, 24d. The mobile device 24a may include a receiver 30. The receiver 30 may be configured to receive a variety of signals from one or more of the base stations 22a, 22b. In one embodiment, the receiver 30 may received an SNR signal from the base station 22a, b. For example, the receiver may receive an SNR calculated based on transmissions between the base station 22a and the mobile device 24a across a pilot channel. In alternate embodiments, however, a different error metric may be received and/or the mobile device 24a may be configured to calculate the error metric itself. For example, the mobile device 24a may be configured to calculate a Packet Error Rate (“PER”).

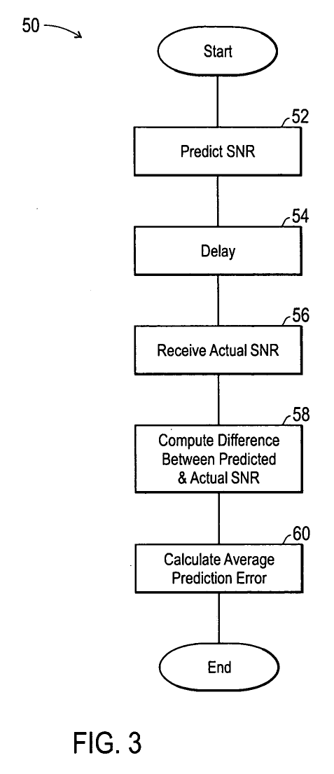

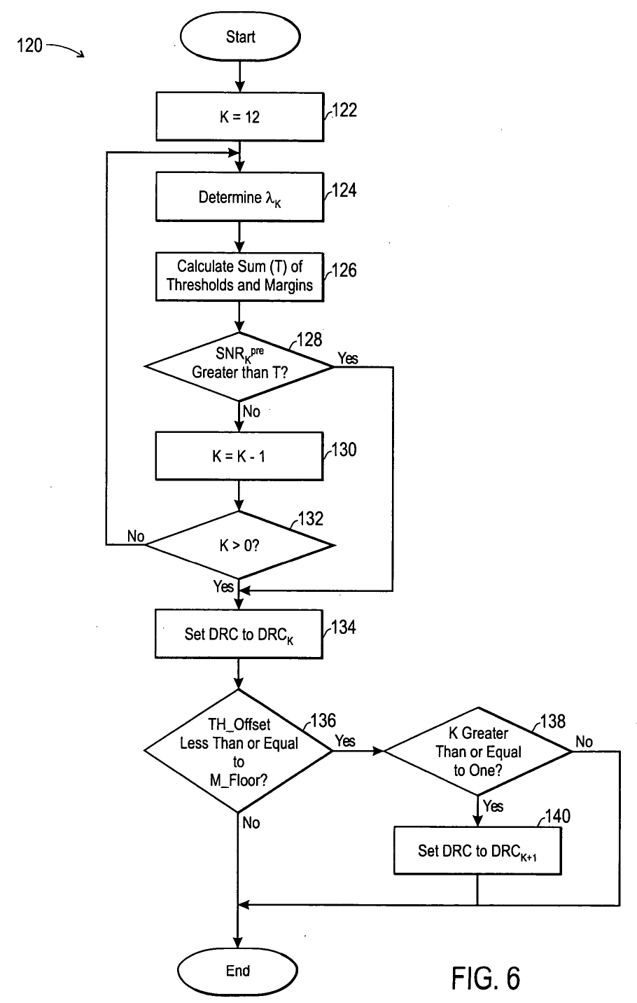

The receiver 30 may pass the received SNR signals to an SNR prediction error calculator 32. Amongst other things, the SNR prediction error calculator 32 may be configured to predict an SNR, referred to as the SNR^{pre}, and to calculate a prediction error (“PE”) associated with the SNR^{pre}. As described further below with regard to FIG. 6, the SNR^{pre} and the PE may be used to select a DRC for the base station 22a, 22b to use to communicate with the mobile devices 24a, 24b, 24c, and 24d. The SNR prediction error calculator 32 may determine the PE by comparing the SNR^{pre} to an actual measured SNR, which may be measured later. Accordingly, FIG. 3 is a flowchart illustrating an exemplary technique that the SNR prediction error calculator 32 may employ to calculate the PE in accordance with one embodiment. In the embodiment, described below, the technique 50 is performed by the SNR prediction calculator 32 within the mobile device 24a. In alternate embodiments, the technique 50 (as well as the techniques 70, 90, and 120 described below) may also be performed by the base stations 22a, b or other suitable components of the system 10.

As illustrated in block 52, the technique 50 begins by predicting an SNR (SNR^{pre}). Once the SNR prediction error calculator 32 has predicted the SNR^{pre}, it may delay until a point in the future corresponding to SNR^{pre} (e.g., in the example above 3.33 ms in the future), as indicated in block 54. After delaying until the time that corresponds to the predicted time, the SNR prediction error calculator 32 may receive an actual SNR for that time (e.g., the actual SNR corresponding to the SNR^{pre}), as indicated by block 56.

Next, the SNR prediction error calculator 32 may compute the difference between the SNR^{pre} and the actual SNR to compute the PE, as indicted in block 58. In other words, the PE is the difference between the SNR^{pre} and the actual SNR. In one embodiment, calculating the PE involves calculating a running average of the prediction error using an infinite impulse response feature or other suitable digital signal processing (“DSP”) component.

Returning now to FIG. 2, the SNR prediction error calculator 32 may be coupled to an outer loop 34 and/or an inner loop 36. As will be described further below, the outer loop 34 may determine a threshold offset (“TH_Offset”) that can be employed to adjust an SNR threshold (“TH”), where TH is indicative of the SNR in decibels (“dB”) that can be tolerated by the base station 22a, b while still maintaining a particular PER for an Additive White Gaussian Noise Channel (“AWGN”) on the packet channel. In other words, the TH_Offset may be employed to adjust the TH to represent the SNR in decibels (“dB”) that can be tolerated by the base station 22a, b on the packet channel while approximately maintaining the target PER for a particular channel condition instead of the AWGN channel. As described further below, a single TH_Offset may be applied to all of the DRCs.

In one embodiment, the outer loop 34 may include a computer system running base station application software. In alternate embodiments, however, the outer loop 34 may include an application specific integrated circuit (“ASIC”), a field programmable gate array (“FPGA”), a processor, such as a DSP, or another suitable processing or computing component.

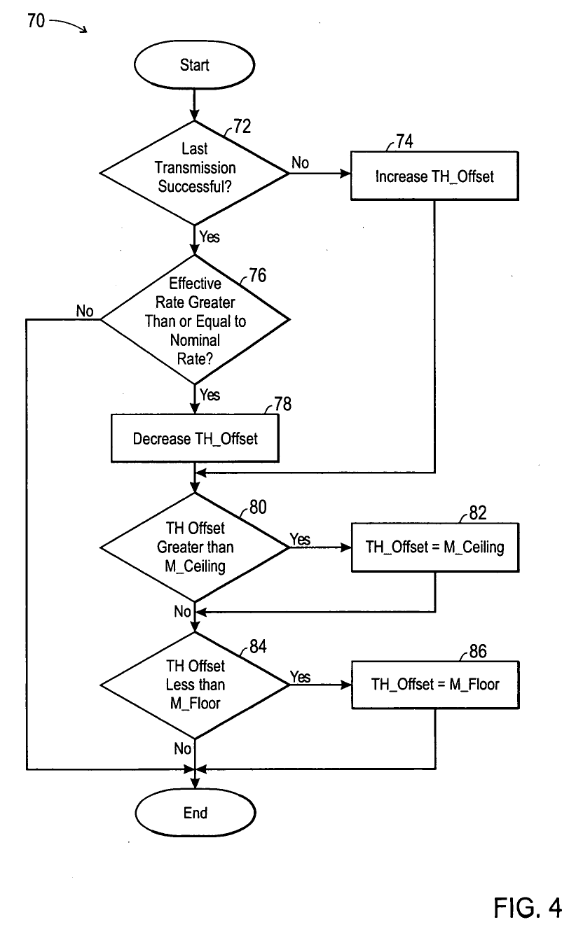

As described above, the outer loop 34 may be configured to compute the TH_Offset. As such, FIG. 4 illustrates an exemplary technique 70 that the outer loop 34 may use to determine the TH_Offset in accordance with one embodiment. As indicated by block 72, the technique 70 may begin with the outer loop 34 determining whether the last transmission from the base station 22a, b was successful. The outer loop 34 may judge the last transmission to be successful if the PER on the packet channel was around a target PER level (e.g., 1%). If the last transmission was not successful, the outer loop 34 may increase the TH_Offset, as indicated in block 74. For example, the outer loop 34 may increase the TH_Offset by a dB step (e.g., 0.5 dB). It will be appreciated that increasing the TH_Offset will increase the SNR level associated with each of the data rates and/or transmission formats employed by the base station 22a, b. In this way, increasing the TH_Offset may cause the mobile device 24a to be more conservative in selecting DRCs, because a higher TH_Offset causes the mobile device 24a to equate a higher SNR with the PER target than the mobile device 24a would if the TH_Offset were lower. After increasing the TH_Offset, the outer loop 34 may proceed to block 80, as will be described below.

Returning to block 72, if the last transition was successful, the outer loop 34 may determine whether the effective transmission rate for the last transmission was greater than or equal to a nominal data rate as indicated by block 76. The effective data rate is the size of the packet actually transmitted divided by the number of time slots that it actually took to transmit the packet, whereas the nominal data rate is the packet size divided by a nominal or canonical packet length (e.g., the packet length illustrated in Table 1). If the effective data rate is not greater than or equal to the nominal data rate, the technique 70 may end as illustrated in FIG. 4, because if the last transmission was successful but not at a data rate greater than the nominal rate, it may not be advantageous to adjust the TH_Offset because TH as adjusted by the current TH_Offset is already close enough.

If, however, the effective data rate is greater than the nominal data rate, the outer loop 34 may decrease the TH_Offset, as indicated in block 78, because a higher effective data rate may indicate that the channel conditions are closer to an AGWN channel than the current TH_Offset would indicate. In one embodiment, the outer loop 34 may decrease the TH_Offset by a dB step (e.g., 0.5 dB) multiplied by a PER target value. In alternate embodiments, the TH_Offset may be decreased by a different amount. It will be appreciated that decreasing the TH_Offset may decrease the SNR associated with a particular channel condition and thereby facilitate the selection of more aggressive (e.g., faster) data rates and/or transmission formats by the mobile devices 24a.

The outer loop 34 may also compare the TH_Offset to ceiling and floor values: M_Ceiling and M_Floor, as indicated by blocks 80, 82, 84, and 86. The M_Ceiling and M_Floor values enable the outer loop 34 to place upper and lower limits to be on value of TH_Offset, which allows designers or operators of the base station 22a, b to artificially establish absolute parameters for TH_Offset, if desired. Accordingly, as illustrated in FIG. 4, the outer loop 34 may compare the TH_Offset value to the M_Ceiling value, and if the TH_Offset value exceeds the M_Ceiling value, the outer loop 34 may set the TH_Offset value equal to the M_Ceiling value. Likewise, the outer loop 34 may determine whether the TH_Offset value is less than the M_Floor value, and if the TH_Offset value is less than the M_Floor value, the outer loop 34 may set the TH_Offset value equal to the M_Floor value.

As described above, the mobile device 24a may also contain the inner loop 36. The inner loop 36 may be configured to adjust the relationship (referred to as the SNR threshold margins) between the DRC values and particular signal-to-noise ratio (“SNR”) values for a given packet error rate (“PER”) target. In one embodiment, the inner loop 36 includes an ASIC. In alternate embodiments, however, the inner loop 36 may include an FPGA, a processor, such as a DSP, a computer or other processor executing application software, and so forth.

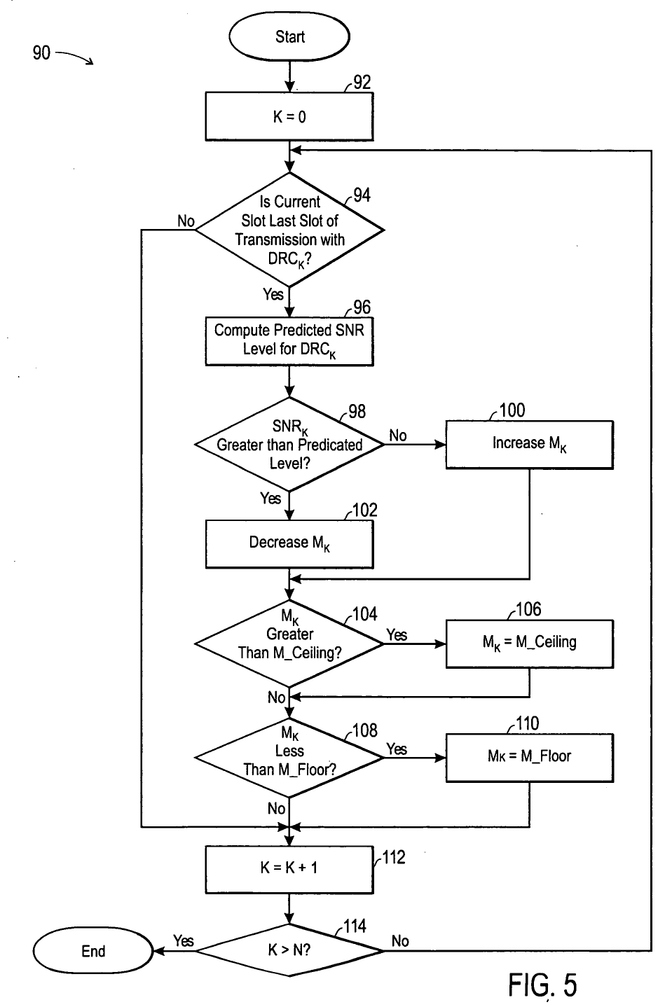

As described above, the inner loop 36 may be configured to adjust SNR threshold margins associated with a DRC list (see Table 1, for example). Accordingly, FIG. 5 illustrates an exemplary technique 90 that the inner loop 36 may perform to adjust the SNR threshold margins associated with each of the DRCs. As illustrated in FIG. 5, the technique 90 may begin with the inner loop 36 setting a counter variable K equal to zero, as indicated in block 92. The counter variable K may be employed to store a value corresponding to a particular one amongst the plurality of DRCs.

As indicated by block 94, the inner loop 36 may also determine whether the current slot is the last slot of the transmission employing the first DRC (e.g., the DRC_{K} where K=12). For example, the inner loop 36 may determine whether the current slot is the 16^{th} slot in a 16 slot packet with a data rate of 38.4 kbps for the first DRC illustrated in Table 1. If the current slot is not the last slot of the transmission, the inner loop 36 will proceed to block 112, because the inner loop 36 may be configured to adjust the SNR threshold margins after a transmission is complete.

If the current slot is the last slot of the transmission, the inner loop 36 may compute SNR^{pre} for the DRC_{K}, as indicated by block 96. In one embodiment, the SNR^{pre} may be calculated by adding at least the following: (1) TH for the DRC_{K} (described above with regard to FIG. 4); (2) a Doppler penalty associated with the DRC_{K,} wherein the Doppler penalty may be function of the average prediction error (PE) calculated by the SNR Prediction Calculation 32; and (3) the TH_Offset. The inner loop 36 may also determine whether the actual SNR is greater than the SNR^{pre}, as indicated in block 98. If the actual SNR is less than the SNR^{pre}, the inner loop 36 may increase an SNR threshold margin M_{K} associated with the DRC_{K}. This action may be taken because if the actual SNR associated with the DRC_{K} was better than expected, it can indicate that SNR threshold margin associated with the DRC_{K} were low. In one embodiment M_{K} may be measured in dB and increasing M_{K} may involve increasing the dB level of M_{K} by a programmed number of dBs. If, however, the actual SNR is greater than the SNR^{pre}, the inner loop 36 may decrease M_{K} as indicated by block 102. In one embodiment, the inner loop 36 may decrease M_{K} by an amount equal to 0.5 dB times the PER target value.

Next, the inner loop 36 may compare the M_{K} to ceiling and floor values: M_Ceiling and M_Floor, as indicated by blocks 104, 106, 108, and 110. The M_Ceiling and M_Floor values enable artificial upper and lower limits to be placed on M_{K}. Accordingly, as illustrated in FIG. 5, the inner loop 36 may compare M_{K} to the M_Ceiling value, and if M_{K} exceeds the M_Ceiling value, the inner loop 36 may set M_{K} equal to the M_Ceiling value. Likewise, the inner loop 36 may determine whether M_{K} is less than the M_Floor value, and if M_{K} is less than the M_Floor value, the inner loop 36 may set M_{K} equal to the M_Floor value.

Next, the inner loop 36 may increase the value of the counter variable K to enable the inner loop 36 to proceed to the next DRC (if appropriate), as indicated by block 112. After incrementing the counter variable K, the inner loop 36 will determine whether the value stored in the counter variable K is greater than a value N, as indicated by block 114. In one embodiment, N is the total number of DRCs that the base station 22a, b may employ in communicating with the mobile devices 24a, 24b, 24c, and 24d (e.g., N is equal to 12 in regards to Table 1). If the value stored in the counter variable K is less than the number of DRCs, the technique 90 will cycle back to the block 94 as illustrated in FIG. 5. If, however, the value stored in the counter variable K exceeds the number of DRCs, the technique 90 will end.

Returning now to FIG. 2, the SNR prediction error calculator 32, the outer loop 34, and the inner loop 36 may be communicatively coupled to a data rate selector 38. As described further below, the data rate selector 38 may employ the TH_Offset and/or the threshold margins M_{K} computed by the outer loop 34 and the inner loop 36 to select a data rate (e.g., a DRC from Table 1) for the base station 22a, 22b to employ to communicate with a particular one of the mobile devices 24a, 24b, 24c, or 24d. In one embodiment, the data rate selector 38 includes DSP. In alternate embodiments, however, the data rate selector 38 may include an ASIC, an FPGA, a computer or other processor executing application software, and so forth.

The data rate selector 38 may be configured to select a DRC for the base station 22a, b to employ to communicate over the packet channel with one or more of the mobile device 24a. FIG. 6 is a flowchart illustrating one exemplary technique 120 that the data rate selector 38 may employ to select a data rate in accordance with one embodiment. The technique 120 may begin by setting the counter variable K to twelve, as indicated by block 122. Similar to the technique 90, the counter variable K within the technique 120 may enable the data rate selector 38 to scroll through each of a plurality of DRCs, such as the DRC illustrated in the Table 1. In the exemplary technique 120, however, K is set to 12 (instead of zero), to facilitate progression from the highest data rate (DRC 12 in Table 1) to the lowest data rate (DRC 1 in Table 1). Accordingly, in alternate embodiments, K may be set equal to another appropriate value depending on the number of DRCs in the DRC list and the order of progression through the DRCs (e.g., lowest to highest instead of highest to lowest).

The data rate selector 38 may also determine a parameter λ associated with the DRC_{K,} as indicated in block 124. The parameter λ may be employed by the data rate selector 38 to include or exclude the average prediction error (PE) from the calculations described below if the packet length is relatively short. The parameter λ is included because if the packet length is relatively short, the SNR^{pre} is typically less accurate and the average prediction error may be included in the calculations. In one embodiment, the parameter λ is set to one if the packet length for the DRC_{K} is greater than four slots and set to zero if the packet length is equal to or less than four slots. After determining the parameter λ, the data rate selector 38 may calculate the sum (T) of the thresholds and the margins associated with the DRC_{K,} as indicated in block 126. In one embodiment, calculating the sum T involves adding the following: (1) the threshold TH_{K}; (2) the Doppler penalty; (3) the parameter λ multiplied by the SNR prediction error (PE); and (4) the threshold margin M_{K}.

Further, the data rate selector 38 may determine whether the SNR^{pre} is greater than the sum T, as indicated in block 128. If the SNR^{pre} is greater than the sum T, the technique 120 may proceed to block 134, as will be described further below. If, however, the SNR^{pre} is less than or equal to the sum T, the data rate selector 38 may determine, if available, another DRC beside the DRC_{K} should be selected. As such, the data rate selector may decrement the counter variable K, as indicated in block 130, to move on to the next lower DRC value. After decrementing the counter variable K, the data rate selector 38 may determine whether the current value stored in the counter variable K is equal to zero, as indicated in block 132. If the value stored in the counter variable K is not equal to zero (e.g., there are remaining DRCs to check), the data rate selector 38 may return to block 124.

If, however, the value stored in the counter variable K is equal to zero or the SNR^{pre} was greater than the sum T (see block 128), the data rate selector 38 may select DRC_{K} as the DRC to employ in transmitting to a particular one of the mobile devices. Next, the data rate selector 38 may determine whether the TH_Offset is less than or equal to the M_Floor value, as indicated in block 136. If the TH_Offset value is less than or equal to the M_Floor, however, the data rate selector 38 may change the selected DRC to DRC_{K-1} (blocks 138 and 140). This may be the case because if the TH_Offset is already at the lowest value, the data rate selector 38 may be configured to be a little aggressive and move the DRC up one position on the DRC list.

Returning for a final time to FIG. 2, once the data rate selector 38 has selected a data rate for the base station 22a, b to use to transmit across the packet channel or channels to a particular one of the mobile devices 24a, 24b, 24c, or 24d, the data rate selector 38 may send this information to a transmitter 40. The transmitter 40 may then send the selected data rate (e.g., the DRC) to the base station 22a, b for the base station 22a, b to employ to transmit data to one of the mobile devices 24a, 24b, 24c, or 24d.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

We claim:

1. A method comprising:
selecting one of a plurality of data rate control values for a transmission based on an adjustable relationship between the selected data rate control value and a transmission error margin related to the selected data rate control value.

2. The method, as set forth in claim 1, comprising adjusting the adjustable relationship based on a predicted transmission error rate.

3. The method, as set forth in claim 3, wherein adjusting the relationship comprises adjusting the relationship based on a Packet Error Rate.

4. The method, as set forth in claim 1, comprising transmitting the data rate control value to a base station.

5. The method, as set forth in claim 3, comprising:
receiving a transmission error rate;
comparing the received transmission error rate to the predicted transmission error rate, wherein adjusting the relationship comprises increasing the transmission error margin if the received transmission error rate is less than the predicted transmission error rate.

6. The method, as set forth in claim 3, comprising:
receiving a transmission error rate;
comparing the received transmission error rate to the predicted transmission error rate, wherein adjusting the relationship comprises decreasing the transmission error margin if the received transmission error rate is greater than the predicted transmission error rate.

7. The method, as set forth in claim 1, comprising determining an offset value for the transmission error margin based on the predicted transmission error, wherein selecting the data rate control value is based at least partially on the offset value.

8. The method, as set forth in claim 1, comprising calculating a prediction error, wherein selecting the data rate control value is based on the average prediction error.

9. The method, as set forth in claim 1, wherein predicting a transmission error rate comprises predicting a signal-to-noise ratio.

10. A telecommunication device comprising:
an inner loop configured to adjust a transmission error margin associated with one of a plurality of data rate control values based on a predicted transmission error; and
a data rate selector configured to select a data rate control value for a packet channel based on the transmission error margins.

11. The telecommunication device, as set forth in claim 10, comprising a prediction error calculator configured to calculate the predicted transmission error;

12. The telecommunication device, as set forth in claim 10, comprising a transmitter configured to transmit a wireless signal on the packet channel employing a data rate and transmission format associated with the data rate control value.

13. The telecommunication device, as set forth in claim 10, comprising an outer loop configured to adjust an offset, wherein the data rate selector is configured to select the data rate control value based at least partially on the offset.

14. The system, as set forth in claim 9, comprising a receiver configured to receive a transmission error rate from the base station, wherein the prediction error calculator predicts the transmission error rate based on the received transmission error rate.

15. The system, as set forth in claim 13, wherein the receiver is configured to receive a signal-to-noise ratio.

16. A method comprising:
computing a predicted signal-to-noise ratio level for a first data rate control value;
determining if an actual signal-to-noise ratio is greater than the predicted level;
increasing a margin value associated with the signal-to-noise ratio if the actual signal-to-noise ratio is not greater than the predicted level; and
decreasing the margin if the actual signal-to-noise ratio is greater than the predicted level.

17. The method, as set forth in claim 16, comprising comparing the margin to an upper limit and setting the margin equal to the upper limit if the signal-to-noise ratio threshold margin exceeds the upper limit.

18. The method, as set forth in claim 16, comprising comparing the margin to a lower limit and setting the margin equal to the lower limit if the margin is less than the lower limit.

19. The method, as set forth in claim 16, comprising computing a predicted signal-to-noise ratio level for a second data rate control value.

20. The method, as set forth in claim 16, comprising selecting a transmission format from amongst a plurality of transmission formats based on the margin.
